(19) United States
(12) Patent Application Publication
(10) Pub. No.: US 2015/0263552 A1
(43) Pub. Date: Sep. 17, 2015

(54) ELECTRONIC DEVICE CHARGER

(71) Applicant: Ergotron, Inc., St. Paul, MN (US)

(72) Inventor: William Dale Tischer, Shoreview, MN (US)

(21) Appl. No.: 14/632,417

(22) Filed: Feb. 26, 2015

Related U.S. Application Data
(60) Provisional application No. 61/951,768, filed on Mar. 12, 2014.

(51) Int. Cl. H02J 7/00

(52) U.S. Cl. CPC H02J 7/0042

(57) ABSTRACT

A charger for charging a power source of an electronic device. The charger can include a power supply to receive a first voltage and convert the received voltage to a first converted voltage, an electrical component connected to the power supply, the electrical component to receive the first converted voltage and output a voltage less than the first converted voltage due to resistive losses, a converter connected to the electrical component, the converter to receive the voltage less than the first converted voltage and convert the voltage less than the first converted voltage to a second converted voltage, wherein the second converted voltage is less than the first converted voltage, and a device connector, wherein the connector is connected to the at least one converter, and wherein the device connector is configured to receive the second converted voltage and output the second converted voltage to the electronic device.

This application claims the benefit of priority of U.S. Provisional Patent Application Ser. No. 61/951,768, titled “ELECTRONIC DEVICE CHARGER” to William D. Tischer, and filed on Mar. 12, 2014, the entire content of which being incorporated herein by reference.

### TECHNICAL FIELD

This document pertains generally, but not by way of limitation, to devices and methods for charging electronic devices.

### BACKGROUND

Portable electronic devices typically include an integrated power source, such as a rechargeable battery, for supplying electricity to power the electronic device when the electronic device is not connected to a wall outlet. Typically, a charger for recharging the battery comprises plugs or connectors for interfacing with the electronic device and a wall outlet. The plugs or connectors are linked by an elongated cable. The voltage of the wall outlet is typically about 90 Volts (V) to about 256 V, while the charging voltage for the electronic device can be less than 21 V and often around 5 V. In addition, the charging voltage for each electronic device can vary from device to device and manufacturer to manufacturer. Accordingly, chargers typically include a power supply, which converts the alternating current (AC) voltage of the wall outlet to the appropriate direct current (DC) voltage for the particular electronic device. If the converted DC voltage is too high, the power source, e.g., rechargeable battery, or other circuitry in the device can be damaged. If the DC converted voltage is too low, the power source may not be charged in an efficient manner, e.g. charging times may be increased. The problem can be exaggerated in multi-port chargers in which the electricity drawn from the wall outlet is typically converted at a single power supply and divided among a plurality of charger outlets and the electronic devices connected thereto as illustrated in FIG. 1.

Consumers often continue to operate the electronic device or leave the electronic device powered on while the power source is being charged. The continued operation of the electronic device consumes power that would otherwise be used to recharge the power source. Although the converted voltage is typically set to allow simultaneous use and charging of the electronic device, the processing power, screen size and other features of electronic devices can increase the power demands of the electronic device. Accordingly, any resistive losses in the charger can substantially impact the ability of the charger to efficiently charge the power source.

A competing concern is that consumers prefer longer charger cables for positioning the plug for the electronic device at locations remote from the wall outlet that can be more easily accessed. Similarly, consumers also prefer thinner cables to make the cables less visible. The longer, thinner cable dimensions can increase the resistive losses across the cable.

Another source of resistive losses is the visual indicators that indicate whether the electronic device is connected to the charger and/or whether the power source is being charged. The visual indicators are often particularly desirable in multi-port chargers where multiple electronic devices are connected to a single charger. Typically, the visual indicators can include current sense resistors and associated amplifiers, comparators and at least one light source. If the resistor is too large, the resulting resistive losses can substantially slow charging time and can prevent detection of whether the device is connected. In some example configurations, at least one resistor is required for detecting when the electronic device is connected and at least one resistor is required for detecting charging of the power source. As such, many chargers may only provide one (or neither) feature to minimize the resistive losses.

Another source of resistive losses are the limited power source components in chargers having user-accessible connectors, such as universal serial bus (USB) connectors, that certain government regulations require. The limited power source components can include a positive temperature coefficient device that acts as a resettable fuse to provide overcurrent protection to the charger. However, the limited power source components can also increase the resistive losses in the charger even when the current is within acceptable limits.

### OVERVIEW

The present inventors have recognized, among other things, that a problem to be solved can include efficiently charging the power source of an electronic device in view of the increasing power demands of electronic devices during charging and lossy electrical components, e.g., components that dissipate power. In an example, the present subject matter can provide a solution to this problem, such as by providing a distributive power system including a power supply that can be connected to a plurality of converters. The power supply can be connected to a wall outlet to draw electricity from the wall outlet and convert the voltage of the wall electricity to a first converted voltage. The converters can be configured to receive the electricity at the first converted voltage and convert the voltage of the received electricity to a second converted voltage. Visual indicators, limited power source components and other lossy components can be positioned between the power supply and the converter. The predetermined difference between the first converted voltage and the second converted voltage can account for the resistive losses from the lossy components such that the voltage of the electricity arriving at the electronic device closely approximates the effective operating voltage of the electronic device. In another example, a multi-port charger can include a distributive power source including a power supply connected to a plurality of converters. Each converter can be connected to a cable and a plug or connector for connecting the converter to an electronic device. The multi-port charger can include at least one lossy component, such as visual indicators or limited power source components, corresponding to each converter. The lossy components can be positioned between the power supply and the converters.

In another example, the power supply can be connected to a wall outlet and convert the electricity drawn from the wall outlet to a first converted voltage. Similarly, each converter can be configured to convert the voltage of the electricity received from the power supply to a second converted voltage. The first converted voltage can be set such that the electricity reaching the converter exceeds the operating voltage of the intended electronic device after resistive losses from the lossy electrical components positioned between the power supply and each converter. In this configuration, the second converted voltage can be set to approximate the ideal operating voltage of the intended electronic device. Accordingly, the only resistive loss between the converter and the electronic device results from the cable. In addition, the voltage at the electronic device is at or near the voltage appropriate for efficiently charging the power source.

In another example, a method of charging a plurality of electronic devices including providing a power supply connected to a plurality of converters, wherein at least one lossy component is positioned between each converter and the power supply. The method further includes connecting the power supply to a wall outlet to draw electricity from the wall outlet at a wall voltage, wherein the power supply is configured to convert the wall voltage to a first converted voltage. The method further includes supplying electricity at the first converted voltage to the converters through the lossy component, wherein the converter is configured to convert the first converted voltage to a second converted voltage. Finally, the method includes connecting the converter to one of the plurality of electronic devices, wherein the second converted voltage corresponds to the operating voltage of the connected electronic device.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an existing charger.

FIG. 2 is a block diagram of an example of a charger in accordance with various techniques of this disclosure.

FIG. 3 is a block diagram of an example of a charger in accordance with various techniques of this disclosure.

### DETAILED DESCRIPTION

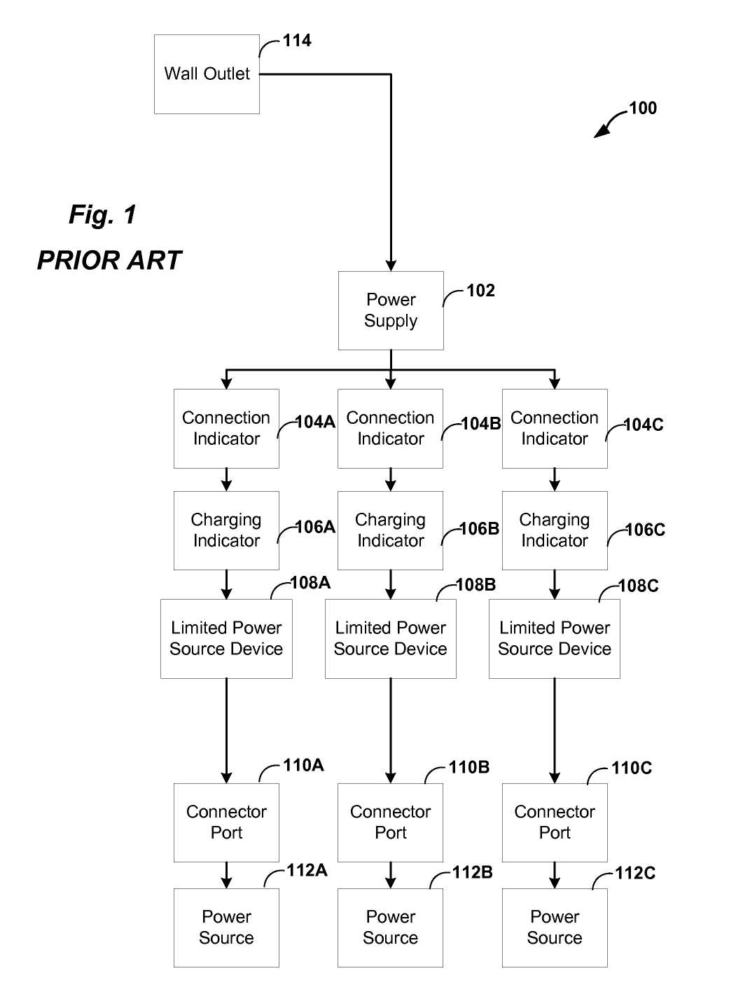

FIG. 1 is a block diagram of an existing charger. In FIG. 1, a charger 100 is shown that can include a power supply 102, one or more lossy electrical components, e.g., one or more connection indicators 104A, 104B, 104C (collectively referred as “connection indicators 104”), one or more charging indicators 106A, 106B, 106C (collectively referred as “charging indicators 106”), one or more limited power source devices 108A, 108B, 108C (collectively referred as “limited power source devices 108”), and one or more connector ports 110A, 110B, 110C (collectively referred as “connector ports 110”) connected to an output of a respective electrical component. Each of the connector ports 110 can be connected to a respective rechargeable power source 112A, 112B, 112C, e.g., a rechargeable battery, of an electronic device.

The power supply 102 is connected to a wall outlet 114, for example. The wall outlet 114 can provide power at about 120 VAC, e.g. in the United States, or about 230 VAC, e.g., in Europe. The power supply 102 can be configured to convert the power from alternating current (AC) to direct current (DC), e.g., from 120 VAC to 5 VDC. In the existing charger shown in FIG. 1, the resistive losses caused by the lossy electrical components occur at a voltage near the charging voltage of the electronic device(s), e.g., 5 VDC, as supplied by the power supply.

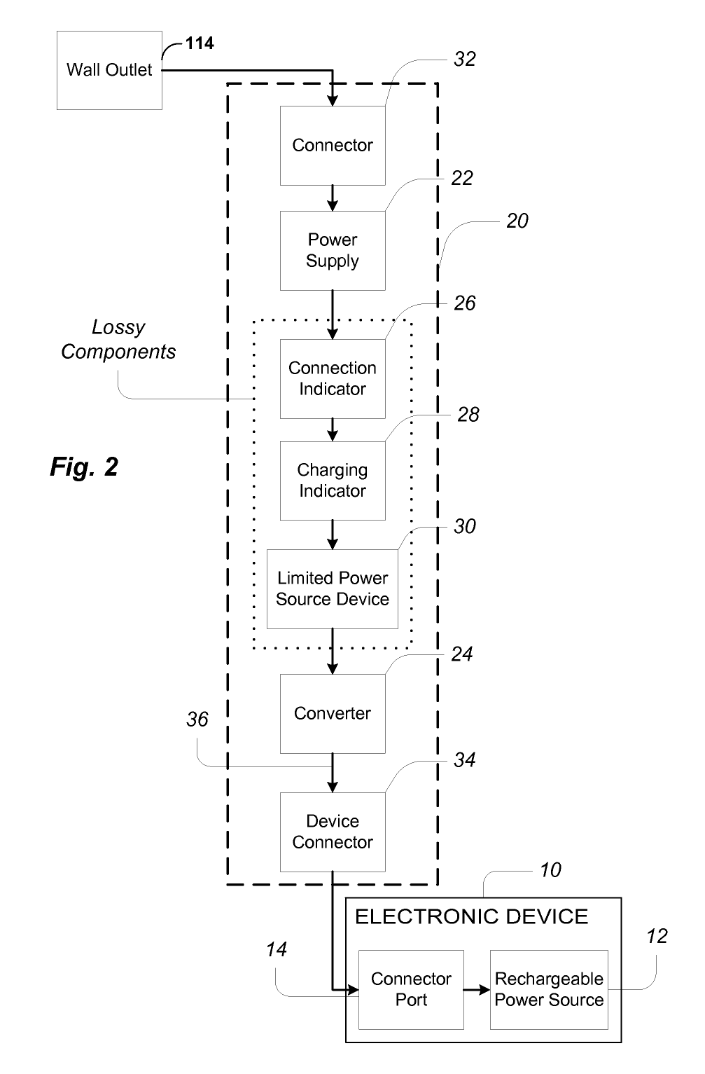

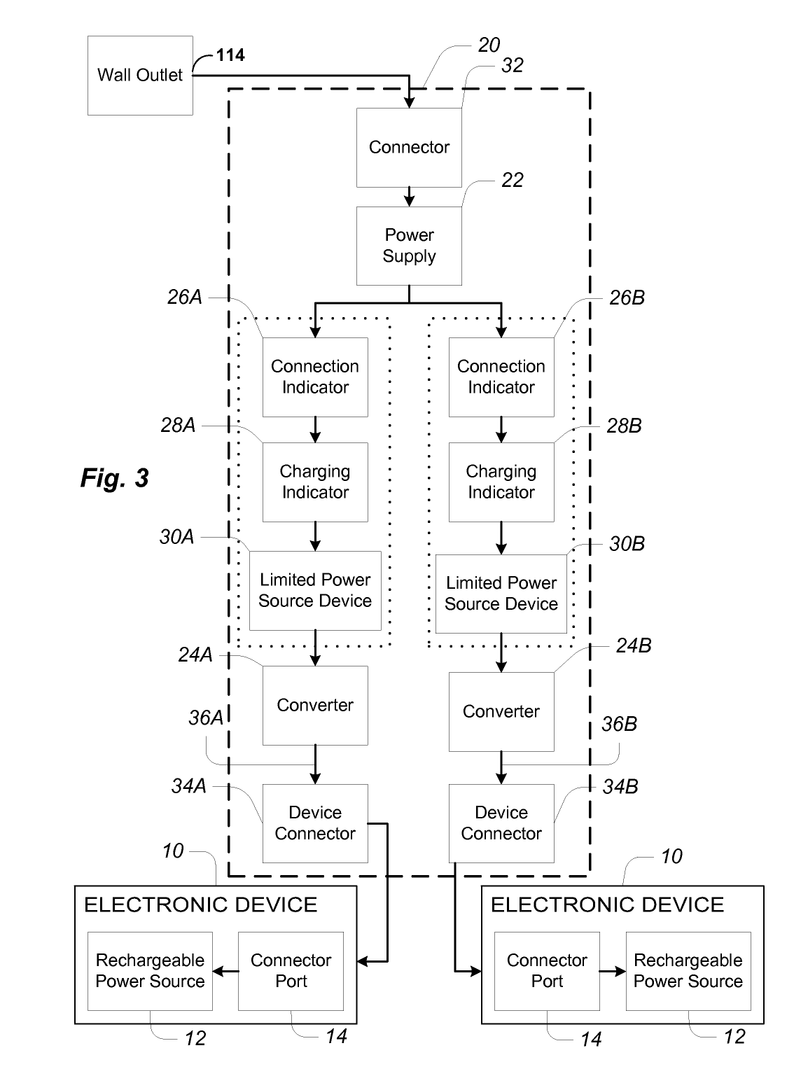

In accordance with this disclosure, and in contrast to the existing techniques of FIG. 1, the examples chargers shown and described below with respect to FIGS. 2 and 3 position the lossy electrical components such that the components are powered at a higher voltage. Power is proportional to the voltage (V) multiplied by the current (I) or V*I, and resistive power losses are proportional to the square of the current (I²) multiplied by the resistance R, or I²R. Thus, for a given amount of a power (VI), there will be less resistive loss at a higher voltage and lower current than at a lower voltage and higher current. The output voltage of the electrical component(s) is then converted to a lower voltage by a converter to charge the power source of the electronic device(s) at a charging voltage.

FIGS. 2 and 3 are examples of chargers that implement various techniques of this disclosure. For purposes of conciseness, the chargers of FIGS. 2 and 3 will be described together.

As depicted in FIGS. 2-3, a charger 20, according to an example, can include a power supply 22, at least one converter 24, e.g., a DC-DC converter such as a buck or boost converter, and at least one electrical component having resistive losses (or “lossy component”), e.g., connection indicator 26, charging indicator 28, limited power source device 30, printed circuit board assembly traces, and the like. The lossy electrical component(s) can be connected to the power supply and configured to receive a first converted voltage from the power supply 22 and output a voltage less than the first converted voltage due to resistive losses.

The charger 20 further includes a connector 32, e.g., for connecting the charger 20 to an outlet, connected to the power supply 22. The connector 32 includes, but is not limited to standard electrical plug configurations for interfacing with standard electrical sockets for electrical outlets. The charger 20 can also include at least one device connector 34 connected to each converter 24. Each device connector 34 may include, but is not limited to, standard USB connectors, mini USB connectors, micro USB connectors, LIGHTNING connectors, FIREWIRE connectors, APPLE 30-pin port and other manufacturer specific power connectors. In an example, the charger 20 can include a plurality of converters 24 in which each converter 24 includes a device connector 34 of a different type as depicted in FIG. 2. In this configuration, the charger 20 can include a combination of different types of device connectors 28 such that different types of electronic devices can be simultaneously charged by the charger 20. The resistive lossy (or simply “lossy”) components for each converter 24 can include, but are not limited to, a connection indicator 26, a charging indicator 28, a limited power source component 30 and combinations thereof

As depicted in FIGS. 2-3, an electronic device 10 for use with the charger 20 can include an integrated power source 12 and a connector port 14. The power source 12 can include a rechargeable battery for supplying operating power to the circuitry of the electronic device 10. In an example, the power source 12 can be configured to receive power within a particular range of operating voltages. The range of operating voltages corresponding to the particular power source 12 can vary based on the size of the power source 12, manufacturer requirements, device requirements and other factors. The connector port 14 can include, but is not limited to, a standard USB port, a mini USB port, a micro USB port, a LIGHTNING port, a FIREWIRE port, an APPLE 30-pin port and other manufacturer specific ports. The description of the device 10 is not intended to be limiting, but to aid in the description of the charger 20. The device connector 34 can be configured to connect with the connector port 14 to connect the charger 20 to the electronic device 10. In an example, the connector port 14 can include an induction element configured to interface with a corresponding induction element of the device connector 34 to wirelessly charge the electronic device 10.

As depicted in FIG. 3, the charger 20, according to an example, includes a single power supply 22, a first converter 24A and a second converter 24B. In this configuration, the first converter 24A is connected to a device connector 34A. One or more lossy electrical components, e.g., a connection indicator 26A, a charging indicator 28A and/or limited power source device 30A, can be positioned between the power supply 22 and the converter 24A. The lossy electrical component(s) are configured to receive the first converted voltage and output a voltage less than the first converted voltage due to resistive losses. Similarly, the second converter 24B is connected to a device connector 34B. One or more lossy electrical components, e.g., a connection indicator 26B, a charging indicator 28B and/or limited power source device 30B, can be positioned between the power supply 22 and the converter 24B. The lossy electrical component(s) are configured to receive the first converted voltage and output a voltage less than the first converted voltage due to resistive losses. In another example, the charger 20 can include additional converters 24 or a single converter 24. The converter 24 is connected to the electrical component(s) and receives the output voltage of the component(s), which is less than the first converted voltage. The converter 24 can convert the voltage less than the first converted voltage to a second converted voltage that is less than the first converted voltage.

By way of specific example, the power supply 22 can output a first converted voltage of 12V, which is received by one or more electrical component(s), e.g., a connection indicator 26B, a charging indicator 28B and/or limited power source device 30B. The output voltage of the electrical component(s) can be less than 12V, due to resistive losses. For example, the voltage may be 11V. This reduced voltage is received by the converter 24. The converter 24 can convert the received voltage to a second converted voltage, where the second converted voltage is less than the first converted voltage. For example, the converter 24 can convert the received 11V to 5V.

As depicted in FIGS. 2-3, in operation, the wall plug 32 can be connected to a wall outlet, for example. The wall outlet can provide power at 120 VAC, e.g. in the United States, or 230 VAC, e.g., in Europe. The power supply 22 can be configured to convert the power from the wall outlet to a first converted voltage. In certain examples, the power supply 22 can be configured to convert the power from alternating current to direct current, e.g., from 120 VAC to 12 VDC. In an example, the first converted voltage can be about 8 VDC to about 48 VDC. The first converted voltage can be greater than the charging voltage of the electronic device.

As depicted in FIG. 3, the example charger 20 can include a plurality of converters 24, e.g., converters, connecting in parallel. The output of the power supply 22 can be distributed to each of the converters 24. As seen in FIG. 2, the lossy components are positioned between power supply 22 and the corresponding converter 24. In this configuration, the resistive losses in the charger 20 occur at a first current and power supply 22 at the first converted voltage supplied by the power supply 22, e.g., 12VDC. The converters 24 can be configured to operate as buck and/or boost converters. In some example configurations, one or more converters 24 can be configured as a buck converter to convert the first converted voltage, e.g., 12 VDC, to a lower, second converted voltage, e.g., 5 VDC. In certain examples, the first converted voltage is between about 8 V and 48 V. In an example, the second converted voltage that is outputted by the converter 24 more closely approximates the charging voltage of the corresponding electronic device to be connected to the device connector 34. In certain examples, the second converted voltage is less than 21 V.

In some example configurations, one or more converters 24 can be configured as a boost converter. For example, if the lossy components reduced the first converted voltage, e.g., 12 VDC, below a charging voltage of an electronic device, one or more converters 24 can increase the voltage to a higher, second converted voltage, e.g., 5 VDC.

This is in contrast to existing techniques, such as shown and described above with respect to FIG. 1. In the existing charger shown in FIG. 1, the resistive losses occur at the lower voltage, e.g., 5 VDC as supplied by the power supply, and at a higher current than the configurations shown in FIGS. 2 and 3. Because the resistive losses are proportional to the square of the current (I²) multiplied by the resistance R, or I²R, there are more resistive losses in the existing charger of FIG. 1 than in the configurations depicted in FIGS. 2 and 3.

Returning again to FIG. 3, in an example, the charger 20 can include a cable 36 connecting the converter 24 to the device connector 34. In this configuration, a source of resistive loss between the converter 24 and the device connector 34 is from the cable 36. In an example, the converter 24 can be configured such that its second converted voltage accounts for the resistive losses from the cable 36. In this manner, the voltage at the device connector 34 can directly correspond to the charging voltage of the electronic device.

### Various Notes and Examples

Example 1 includes subject matter (such as a device, apparatus, or machine) that may comprise: a power supply configured to receive a first voltage and to convert the received voltage to a first converted voltage; at least one electrical component connected to the power supply, the at least one electrical component configured to receive the first converted voltage and output a voltage less than the first converted voltage due to resistive losses; at least one converter connected to the at least one electrical component, the at least one converter configured to receive the voltage less than the first converted voltage and convert the voltage less than the first converted voltage to a second converted voltage, wherein the second converted voltage is less than the first converted voltage; and at least one device connector, wherein each of the at least one device connectors is connected to the at least one converter, and wherein each of the at least one device connectors is configured to receive the second converted voltage and output the second converted voltage to the at least one electronic device.

In Example 2, the subject matter of Example 1 may include, wherein the at least one converter includes a buck converter.

In Example 3, the subject matter of one or more of Examples 1-2 may include, wherein the at least one converter includes a boost converter, and wherein the second converted voltage is greater than the voltage less than the first converted voltage.

In Example 4, the subject matter of one or more of Examples 1-3 may include, wherein the at least one electrical component includes a connection indicator.

In Example 5, the subject matter of one or more of Examples 1-4 may include, wherein the at least one electrical component includes a charger indicator.

In Example 6, the subject matter of one or more of Examples 1-5 may include, wherein the at least one electrical component includes a limited power source component.

In Example 7, the subject matter of one or more of Examples 1-6 may include, wherein the first converted voltage is between about 8 volts to about 48 volts.

In Example 8, the subject matter of one or more of Examples 1-7 may include, wherein the second converted voltage is less than about 21 volts.

In Example 9, the subject matter of one or more of Examples 1-8 may include, wherein the device connector is selected from a group consisting of standard USB connectors, mini USB connectors, micro USB connectors, LIGHTNING connectors, FIREWIRE connectors.

Example 10 includes subject matter (such as a device, apparatus, or machine) that may comprises: a power supply configured to receive a first voltage and to convert the received voltage to a first converted voltage; a first electrical component connected to the power supply, the first electrical component configured to receive the first converted voltage and output a first voltage less than the first converted voltage due to resistive losses; a first converter connected to the first electrical component, the first converter configured to receive the first voltage less than the first converted voltage and convert the first voltage less than the first converted voltage to a second converted voltage, wherein the second converted voltage is less than the first converted voltage; a first device connector connected to the first converter, and wherein the first device connector is configured to receive the second converted voltage and output the second converted voltage to a first one of the at least one electronic devices; a second electrical component connected to the power supply, the second electrical component configured to receive the first converted voltage and output a second voltage less than the first converted voltage due to resistive losses; a second converter connected to the second electrical component, the second converter configured to receive the second voltage less than the first converted voltage and convert the second voltage less than the first converted voltage to a third converted voltage, wherein the third converted voltage is less than the first converted voltage; a second device connector connected to the second converter, wherein the second device connector is configured to receive the third converted voltage and output the third converted voltage to a second one of the at least one electronic devices.

In Example 11, the subject matter of Example 10 may include, wherein at one of the first and second device connectors is selected from a group consisting of standard USB connectors, mini USB connectors, micro USB connectors, LIGHTNING connectors, FIREWIRE connectors and APPLE 30-pin port.

Example 12 includes subject matter (such as a method, means for performing acts, machine readable medium including instructions that when performed by a machine cause the machine to performs acts, or an apparatus to perform) that may comprise: receiving a voltage and converting the received voltage to a first converted voltage; receiving, by at least one electrical component, the first converted voltage and outputting a voltage less than the first converted voltage due to resistive losses; receiving, by a converter, the voltage less than the first converted voltage and converting the voltage less than the first converted voltage to a second converted voltage, wherein the second converted voltage is less than the first converted voltage; and providing the second converted voltage from the converter to a device connector.

In Example 13, the subject matter of Example 12 may include, wherein the at least one electrical component is a connection indicator corresponding to the converter.

In Example 14, the subject matter of one or more of Examples 12 to 13 may include, wherein the at least one electrical component is a charger indicator corresponding to the converter.

In Example 15, the subject matter of one or more of Examples 12 to 14 may include, wherein the at least one electrical component is a limited power source component corresponding to the converter.

In Example 16, the subject matter of one or more of Examples 12 to 15 may include, wherein the first converted voltage is between about 8 volts to about 48 volts.

In Example 17, the subject matter of one or more of Examples 12 to 16 may include, wherein the second converted voltage is less than about 21 volts.

In Example 18, the subject matter of one or more of Examples 12 to 17 may include, wherein the second converted voltage is a charging voltage of the electronic device.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed

Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The invention claimed is:

1. A charger for charging a power source of at least one electronic device, comprising:
a power supply configured to receive a first voltage and to convert the received first voltage to a first converted voltage;
at least one electrical component connected to the power supply, the at least one electrical component configured to receive the first converted voltage and output a voltage less than the first converted voltage due to resistive losses;
at least one converter connected to the at least one electrical component, the at least one converter configured to receive the voltage less than the first converted voltage and convert the voltage less than the first converted voltage to a second converted voltage, wherein the second converted voltage is less than the first converted voltage; and
at least one device connector, wherein each of the at least one device connectors is connected to the at least one converter, and wherein each of the at least one device connectors is configured to receive the second converted voltage and output the second converted voltage to the at least one electronic device.

2. The charger of claim 1, wherein the at least one converter includes a buck converter.

3. The charger of claim 1, wherein the at least one converter includes a boost converter, and wherein the second converted voltage is greater than the voltage less than the first converted voltage.

4. The charger of claim 1, wherein the at least one electrical component includes a connection indicator.

5. The charger of claim 1, wherein the at least one electrical component includes a charger indicator.

6. The charger of claim 1, wherein the at least one electrical component includes a limited power source component.

7. The charger of claim 1, wherein the first converted voltage is between about 8 volts to about 48 volts.

8. The charger of claim 1, wherein the second converted voltage is less than about 21 volts.

9. The charger of claim 1, wherein the device connector is selected from a group consisting of standard USB connectors, mini USB connectors, micro USB connectors, LIGHTNING connectors, FIREWIRE connectors.

10. A charger for charging a power source of at least one electronic device, comprising:
a power supply configured to receive a first voltage and to convert the received voltage to a first converted voltage;
a first electrical component connected to the power supply, the first electrical component configured to receive the first converted voltage and output a first voltage less than the first converted voltage due to resistive losses;
a first converter connected to the first electrical component, the first converter configured to receive the first voltage less than the first converted voltage and convert the first voltage less than the first converted voltage to a second converted voltage, wherein the second converted voltage is less than the first converted voltage;
a first device connector connected to the first converter, and wherein the first device connector is configured to receive the second converted voltage and output the second converted voltage to a first one of the at least one electronic devices;
a second electrical component connected to the power supply, the second electrical component configured to receive the first converted voltage and output a second voltage less than the first converted voltage due to resistive losses;
a second converter connected to the second electrical component, the second converter configured to receive the second voltage less than the first converted voltage and convert the second voltage less than the first converted voltage to a third converted voltage, wherein the third converted voltage is less than the first converted voltage;
a second device connector connected to the second converter, wherein the second device connector is configured to receive the third converted voltage and output the third converted voltage to a second one of the at least one electronic devices.

11. The charger of claim 10, wherein at one of the first and second device connectors is selected from a group consisting of standard USB connectors, mini USB connectors, micro USB connectors, LIGHTNING connectors, FIREWIRE connectors and APPLE 30-pin port.

12. A method of charging an electronic device, comprising:
receiving a voltage and converting the received voltage to a first converted voltage;
receiving, by at least one electrical component, the first converted voltage and outputting a voltage less than the first converted voltage due to resistive losses;
receiving, by a converter, the voltage less than the first converted voltage and converting the voltage less than the first converted voltage to a second converted voltage, wherein the second converted voltage is less than the first converted voltage; and
providing the second converted voltage from the converter to a device connector.

13. The method of claim 12, wherein the at least one electrical component is a connection indicator corresponding to the converter.

14. The method of claim 12, wherein the at least one electrical component is a charger indicator corresponding to the converter.

15. The method of claim 12, wherein the at least one electrical component is a limited power source component corresponding to the converter.

16. The method of claim 12, wherein the first converted voltage is between about 8 volts to about 48 volts.

17. The method of claim 12, wherein the second converted voltage is less than about 21 volts.

18. The method of claim 16, wherein the second converted voltage is a charging voltage of the electronic device.
